(19) United States
(12) Patent Application Publication
(10) Pub. No.: US 2004/0181985 A1
(43) Pub. Date: Sep. 23, 2004

(54) Apparatus and method for display

(76) Inventor: Allison Ogden, Beaufort, SC (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/393,104

(22) Filed: Mar. 20, 2003

(51) Int. Cl. G09F 7/04

(52) U.S. Cl. 40/600

(57) ABSTRACT

An apparatus and method of display adapted to overlay and magnetically adhere to magnetically susceptible door surfaces of dual-door or multi-door large kitchen appliances, cabinets, closets or pantries, wherein the apparatus and method provides the display of a completed picture, message, or the like, upon planar alignment or adjacent positioning of all doors of the dual-door or multi-door unit, and wherein the apparatus and method provide a means in which to conceal otherwise mundane or aesthetically displeasing frontal door surfaces of such dual-door or multi-door units. The apparatus and method of the present invention further provides a means in which to protect the door surfaces of such dual-door or multi-door units from inadvertent scratches, scrapes and/or scuffs, or to conceal pre-existing cosmetic damage.

### TECHNICAL FIELD

The present invention relates generally to displays, and more specifically to an apparatus and method of display for effectively displaying pictures, messages, or the like, on a plurality of surfaces, including, but not limited to, dual-door or multi-door large kitchen appliances, cabinets, closets, pantries, or the like.

### BACKGROUND OF THE INVENTION

Often times, door surfaces of large kitchen appliances, cabinets, pantries, or the like, become scratched, dented, and/or suffer from any number of cosmetic damages that unfortunately degrade the external aesthetic appearance of the door surface.

An equally prominent occurrence, especially within the household, is the homeowner's development of boredom with the color or general “factory” appearance of the doors of such large kitchen appliances, cabinets or pantries, often establishing a generally prosaic atmosphere and therefore, imparting upon the homeowner a feeling of apathy upon entering the room.

Unfortunately, without engaging in unduly expensive and burdensome repair or replacement of such doors to remedy the above-addressed cosmetic concerns, many homeowners are left without any cost-effective or feasible avenue in which to remedy same.

Therefore, it is readily apparent that there is a need for an apparatus and method of display adapted to overlay door surfaces of dual-door or multi-door large kitchen appliances, or the like, for conveying a desired message or advertisement thereon, concealing featureless or drab frontal door surfaces, and/or for protecting or concealing same from unintentional cosmetic damage.

### BRIEF SUMMARY OF THE INVENTION

Briefly described, in a preferred embodiment, the present invention overcomes the above-mentioned disadvantages and meets the recognized need for such a device by providing an apparatus and method of display adapted to overlay and magnetically adhere to magnetically susceptible door surfaces of dual-door or multi-door large kitchen appliances, cabinets, closets or pantries, wherein the apparatus and method provides the display of a completed picture, message, or the like, upon planar alignment or adjacent positioning of all doors of the dual-door or multi-door unit, and wherein the apparatus and method provide a means in which to conceal otherwise mundane or aesthetically displeasing frontal door surfaces of such dual-door or multi-door units. The apparatus and method of the present invention further provide a means in which to protect the door surfaces of such dual-door or multi-door units from inadvertent scratches, scrapes and/or scuffs, or to conceal pre-existing cosmetic damage.

According to its major aspects and broadly stated, the present invention in its preferred form is an apparatus and method of display having first and second portions adapted to overlay and magnetically adhere to adjacent first and second magnetically susceptible door surfaces.

More specifically, the present invention is an apparatus and method of display having first and second portions, wherein first and second portions each possess a magnetic backing. Preferably frontally disposed on each of first and second portions is a portion of a whole picture, message or the like, wherein magnetic adherence of first and second portions to adjacent or planarly aligned first and second magnetically susceptible door surfaces permits display of the complete picture, message or the like. First and second portions preferably substantially cover the respective door surfaces to which they are magnetically adhered, thus concealing the underlying door surfaces, and protecting same from inadvertent scratches, scrapes and/or scuffs.

Accordingly, a feature and advantage of the present invention is its ability to magnetically adhere to magnetically susceptible door surfaces of dual-door or multi-door large kitchen appliances, cabinets, closets or pantries, to provide the display of a completed picture, message, or the like, upon planar alignment or adjacent positioning of all doors of the dual-door or multi-door unit.

Another feature and advantage of the present invention is its ability to conceal otherwise mundane or aesthetically displeasing frontal door surfaces of dual-door or multi-door large kitchen appliances, cabinets, closets, pantries, or the like.

Another feature and advantage of the present invention is its ability to provide a means in which to protect the door surfaces of dual-door or multi-door large kitchen appliances, cabinets, closets, pantries, or the like, from inadvertent scratches, scrapes and/or scuffs, or to conceal pre-existing cosmetic damage.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of an apparatus for display according to a preferred embodiment of the present invention;

FIG. 2 is a front view of an apparatus for display according to a preferred embodiment of the present invention shown in use and depicting a first indicia;

FIG. 3 is a front view of an apparatus for display according to a preferred embodiment of the present invention shown in use and depicting a second indicia;

FIG. 4 is a front view of an apparatus for display according to a preferred embodiment of the present invention shown in use and depicting a third indicia;

FIG. 5 is a front view of an apparatus for display according to a preferred embodiment of the present invention shown in use and depicting a fourth indicia;

FIG. 6 is a front view of an apparatus for display according to a preferred embodiment of the present invention shown in use and depicting a fifth indicia;

FIG. 7 is a front view of an apparatus for display according to a preferred embodiment of the present invention shown in use and depicting a sixth indicia;

FIG. 8 is a front view of an apparatus for display according to a preferred embodiment of the present invention shown in use and depicting a seventh indicia;

FIG. 9 is a front view of an apparatus for display according to a preferred embodiment of the present invention shown in use and depicting a eighth indicia;

FIG. 10 is a front view of an apparatus for display according to a preferred embodiment of the present invention shown in use and depicting a ninth indicia;

FIG. 11 is a front view of an apparatus for display according to a preferred embodiment of the present invention shown in use and depicting a tenth indicia;

FIG. 12 is a front view of an apparatus for display according to a preferred embodiment of the present invention shown in use and depicting a eleventh indicia;

FIG. 13 is a front view of an apparatus for display according to a preferred embodiment of the present invention shown in use and depicting a twelfth indicia;

FIG. 14 is a front view of an apparatus for display according to a preferred embodiment of the present invention shown in use and depicting a thirteenth indicia;

FIG. 15 is a front view of an apparatus for display according to a preferred embodiment of the present invention shown in use and depicting a fourteenth indicia;

FIG. 16 is a front view of an apparatus for display according to a preferred embodiment of the present invention shown in use and depicting a fifteenth indicia;

FIG. 17 is a front view of an apparatus for display according to a preferred embodiment of the present invention shown in use and depicting a sixteenth indicia;

FIG. 18 is a front view of an apparatus for display according to a preferred embodiment of the present invention shown in use and depicting a seventeenth indicia;

FIG. 19 is a front view of an apparatus for display according to a preferred embodiment of the present invention shown in use and depicting a eighteenth indicia;

FIG. 20 is a front view of an apparatus for display according to a preferred embodiment of the present invention shown in use and depicting a nineteenth indicia;

FIG. 21 is a front view of an apparatus for display according to a preferred embodiment of the present invention shown in use and depicting a twentieth indicia;

FIG. 22 is a front view of an apparatus for display according to a preferred embodiment of the present invention shown in use and depicting a twenty-first indicia;

FIG. 23 is a front view of an apparatus for display according to a preferred embodiment of the present invention shown in use and depicting a twenty-second indicia;

FIG. 24 is a front view of an apparatus for display according to a preferred embodiment of the present invention shown in use and depicting a twenty-third indicia;

FIG. 25 is a front view of an apparatus for display according to a preferred embodiment of the present invention shown in use and depicting a twenty-four indicia;

FIG. 26 is a front view of an apparatus for display according to an alternate embodiment of the present invention;

FIG. 27 is a front view of an apparatus for display according to an alternate embodiment of the present invention;

FIG. 28 is a front view of an apparatus for display according to an alternate embodiment of the present invention;

FIG. 29 is a front view of an apparatus for display according to an alternate embodiment of the present invention;

FIG. 30 is a front view of an apparatus for display according to an alternate embodiment of the present invention;

FIG. 31 is a front view of an apparatus for display according to an alternate embodiment of the present invention;

FIG. 32 is a front view of an apparatus for display according to an alternate embodiment of the present invention; and,

FIG. 33 is a front view of an apparatus for display according to an alternate embodiment of the present invention.

### DETAILED DESCRIPTION OF THE PREFERRED AND ALTERNATIVE EMBODIMENTS

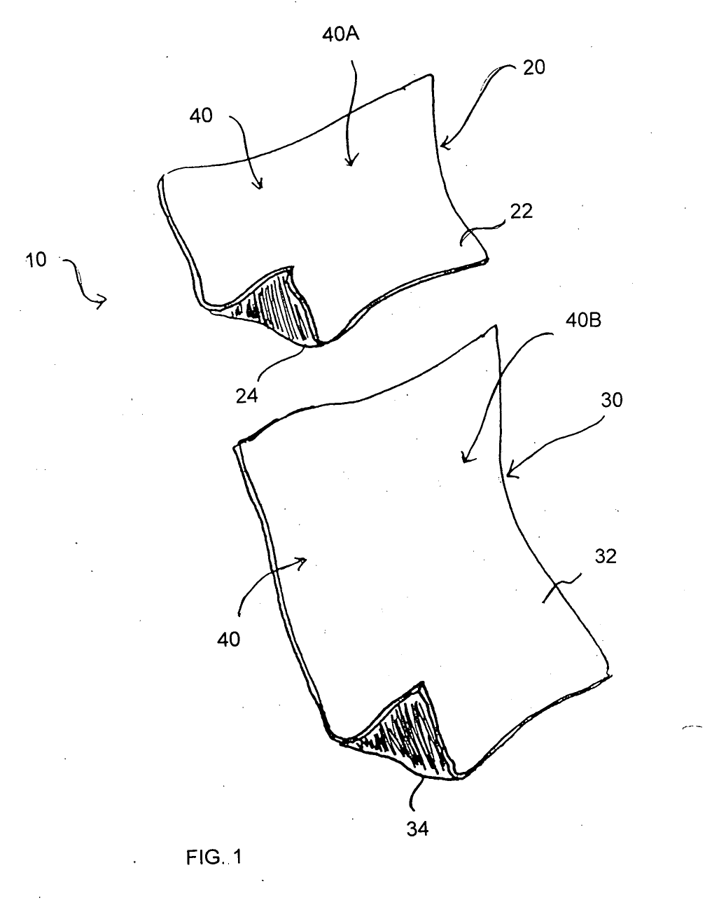

In describing the preferred and selected alternate embodiments of the present invention, as illustrated in FIGS. 1-33, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-25, the present invention in a preferred embodiment is an apparatus for display 10 generally preferably possessing substantially rectangular-shaped first section 20 and substantially rectangular-shaped second section 30, wherein first section 20 and second section 30 are preferably suited for adaptation to a freezer-refrigerator unit. As best illustrated in FIG. 1, first section 20 possesses a smaller length than second section 30 to best accommodate fitting of apparatus 10 to top-freezer refrigerator styles, wherein first section 20 is preferably adapted to the top freezer door, and second section 30 to the lower refrigerator door, as more fully described below. It should be recognized, however, that first section 20, second section 30, or apparatus 10 in general, could be any dimension, configuration or arrangement to facilitate accommodation of any dual-door or multi-door large kitchen appliance, cabinet, closet, pantry, and/or sliding-door versions of same, as such alternate configurations or arrangements of first section 20, second section 30, or apparatus 10 in general, are in full contemplation of the inventor in describing the present invention herein, and could be utilized without departing from the appreciative scope of the present invention.

Preferably, first section 20 possesses display sheet 22 overlaying magnetic sheet 24, wherein display sheet 22 is preferably formed from a canvas material to facilitate the painted and/or printed application of first portion 40A of indicia 40 thereon, and wherein indicia 40 is preferably any desired picture, logo, message, advertisement, or the like, as more fully described below. Although first portion 40A of indicia 40 is preferably painted or printed onto first section 20, it should be recognized that any other suitable means of embodying or incorporating first portion 40A of indicia 40 onto first section 20 could be utilized, such as, for exemplary purposes only, staining, embossing, stitching, silk-screening, or the like. Preferably, display sheet 22 is affixed to magnetic sheet 24 via suitable glues, adhesives or fasteners, such as, for exemplary purposes only, epoxies, resins, epoxy-resin combinations, stitching, riveting, stapling, hook-and-loop fasteners, or the like.

Similarly, second section 30 possesses display sheet 32 overlaying magnetic sheet 34, wherein display sheet 32 is also preferably formed from a canvas material to facilitate the painted and/or printed application of second portion 40B of indicia 40 thereon, and wherein indicia 40 is preferably any desired picture, logo, message, advertisement, or the like, as more fully described below. Although second portion 40B of indicia 40 is preferably painted or printed onto second section 30, it should be recognized that any other suitable means of embodying or incorporating second portion 40B of indicia 40 onto second section 30 could be utilized, such as, for exemplary purposes only, staining, embossing, stitching, silk-screening, or the like. Preferably, display sheet 32 is also affixed to magnetic sheet 34 via suitable glues, adhesives or fasteners, such as, for exemplary purposes only, epoxies, resins, epoxy-resin combinations, stitching, riveting, stapling, hook-and-loop fasteners, or the like.

Although display sheets 22 and 32 are preferably formed from a painted or printed canvas material, it is contemplated in an alternate embodiment that display sheets 22 and 32 could be formed from other suitable materials, such as, for exemplary purposes only, plastic, metal, cardboard, wood, laminates, ceramics, textile fabrics and/or combinations of same, wherein first portion 40A and second portion 40B of the desired indicia 40 would be applied thereon via painting, staining, heat embossing, stitching, silk-screening, printing, or the like. It is contemplated in yet another alternate embodiment that display sheets 22 and 32 could be omitted, wherein respective magnetic sheets 24 and 34 could have first portion 40A and second portion 40B, respectively, of indicia 40 directly painted, imprinted, or incorporated thereon via any other suitable means known within the art.

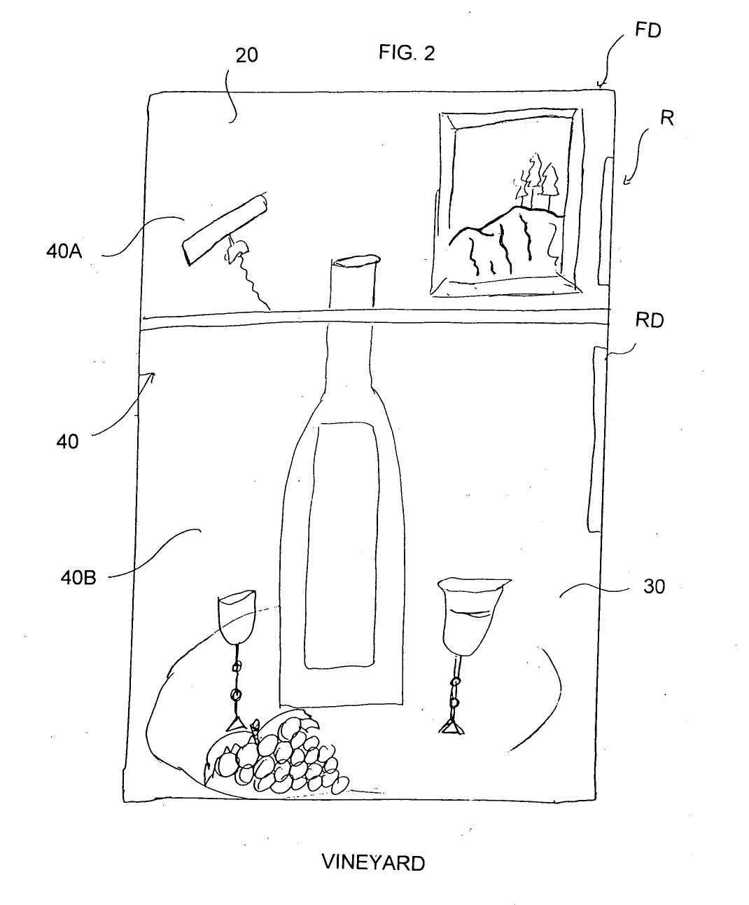

Referring now more specifically to FIGS. 2-25, first section 20 is preferably magnetically adhered, via magnetic sheet 24, to freezer door FD of top-freezer refrigerator R, wherein second section 30 is preferably magnetically adhered, via magnetic sheet 34, to refrigerator door RD of top-freezer refrigerator R. As such, first section 20 preferably outwardly or visually displays first portion 40A of indicia 40, wherein second section 30 preferably outwardly or visually displays second portion 40B of indicia 40.

Preferably, when freezer door FD and refrigerator door RD of top-freezer refrigerator R are in planar alignment, indicia 40 is fully displayed or complete, whereas the opening of either freezer door FD and/or refrigerator door RD results in indicia 40, as a whole, being incomplete.

With specific reference to FIG. 2, indicia 40 is preferably in the form of a wine bottle and related motif, wherein first portion 40A depicts the upper portion of the wine bottle, and wherein second portion 40B depicts the lower portion of the wine bottle in addition to wine glasses.

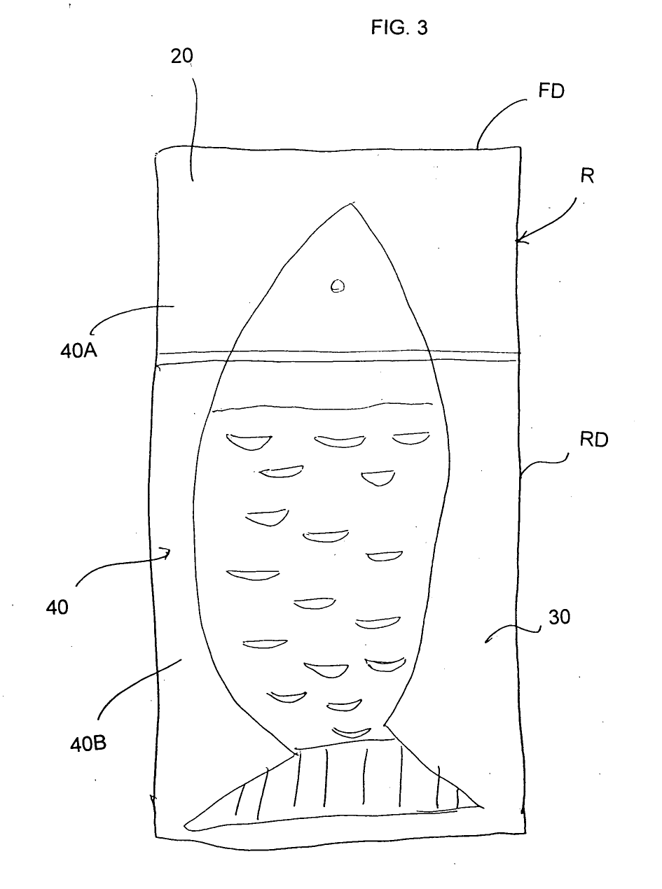

With specific reference to FIG. 3, indicia 40 is preferably in the form of a fish, wherein first portion 40A depicts the head of the fish, and wherein second portion 40B depicts the lower body portion of the fish.

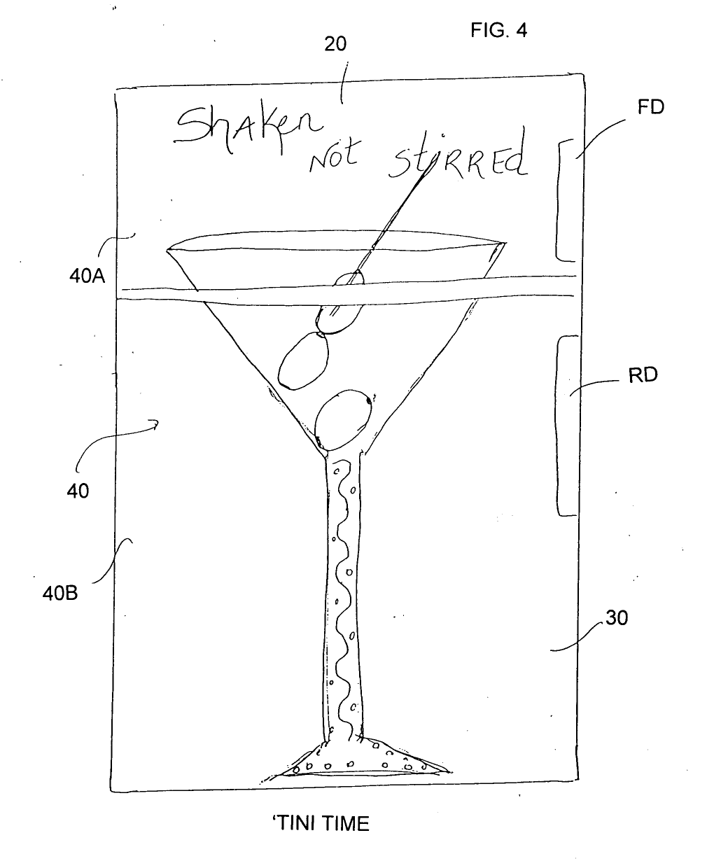

With specific reference to FIG. 4, indicia 40 is preferably in the form of a martini glass, wherein first portion 40A depicts the upper portion of the martini glass, and wherein second portion 40B depicts the lower portion of the martini glass.

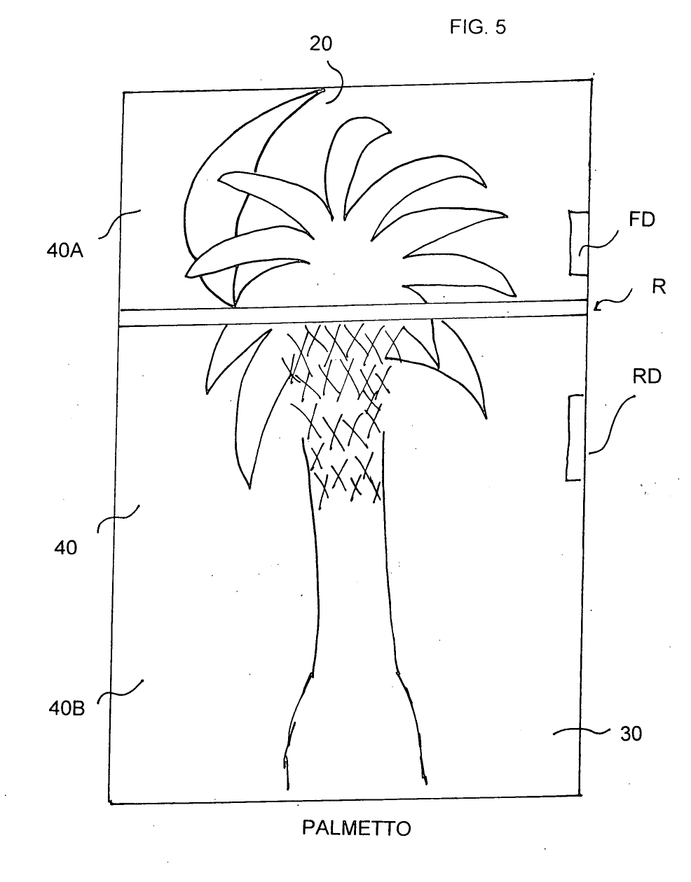

With specific reference to FIG. 5, indicia 40 is preferably in the form of a palm tree, wherein first portion 40A depicts the upper portion of the palm tree, and wherein second portion 40B depicts the lower portion of the palm tree.

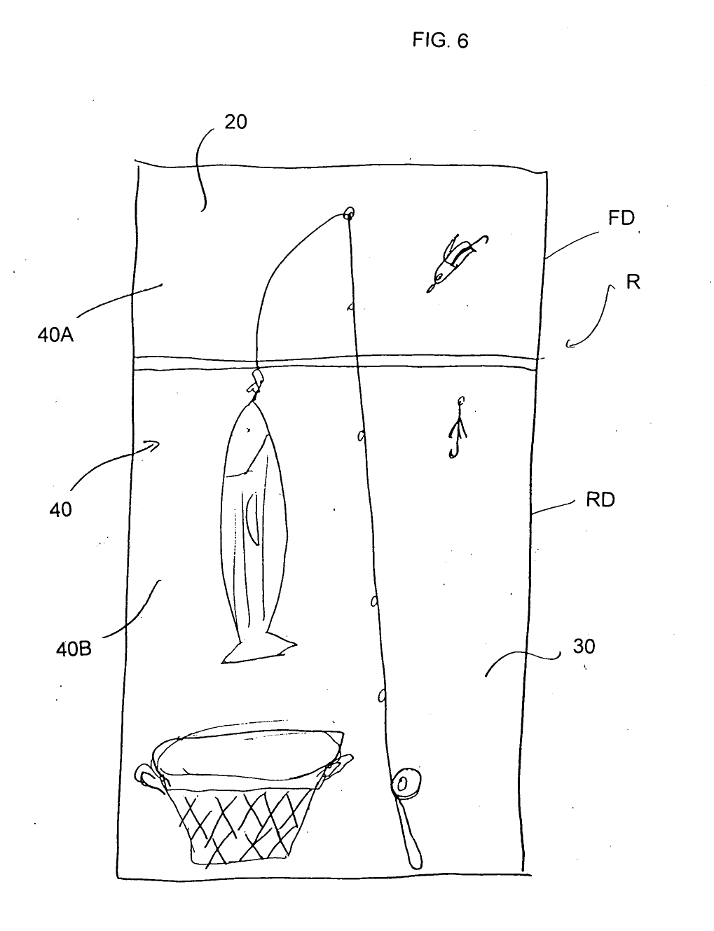

With specific reference to FIG. 6, indicia 40 is preferably in the form of a fishing motif, wherein first portion 40A depicts the upper portion of the fishing motif, and wherein second portion 40B depicts the lower portion of the fishing motif.

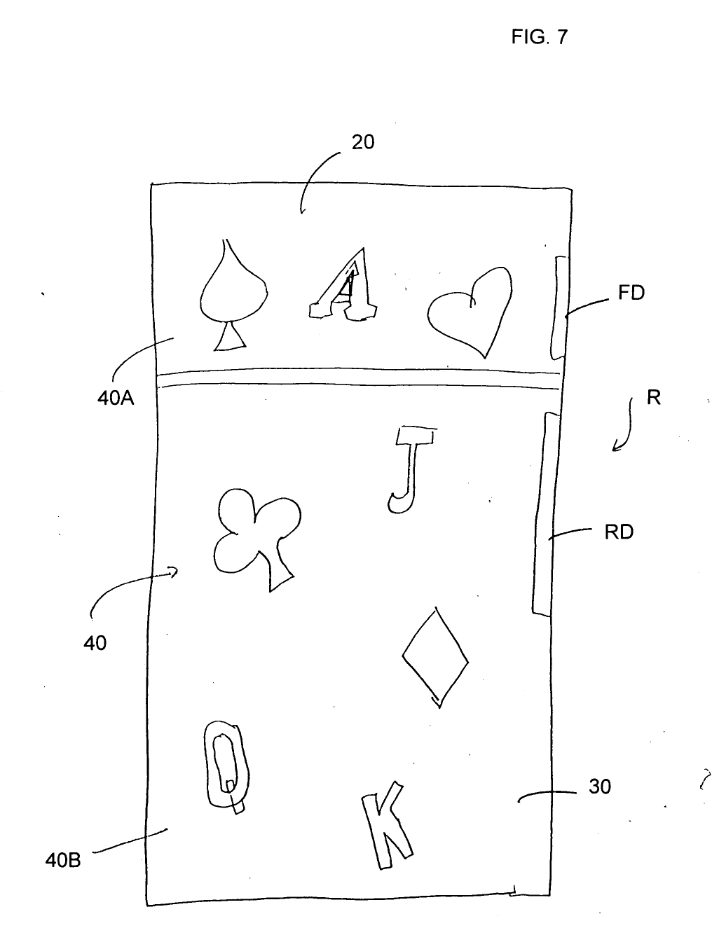

With specific reference to FIG. 7, indicia 40 is preferably in the form of a playing card motif, wherein first portion 40A depicts the upper portion of the playing card motif, and wherein second portion 40B depicts the lower portion of the playing card motif.

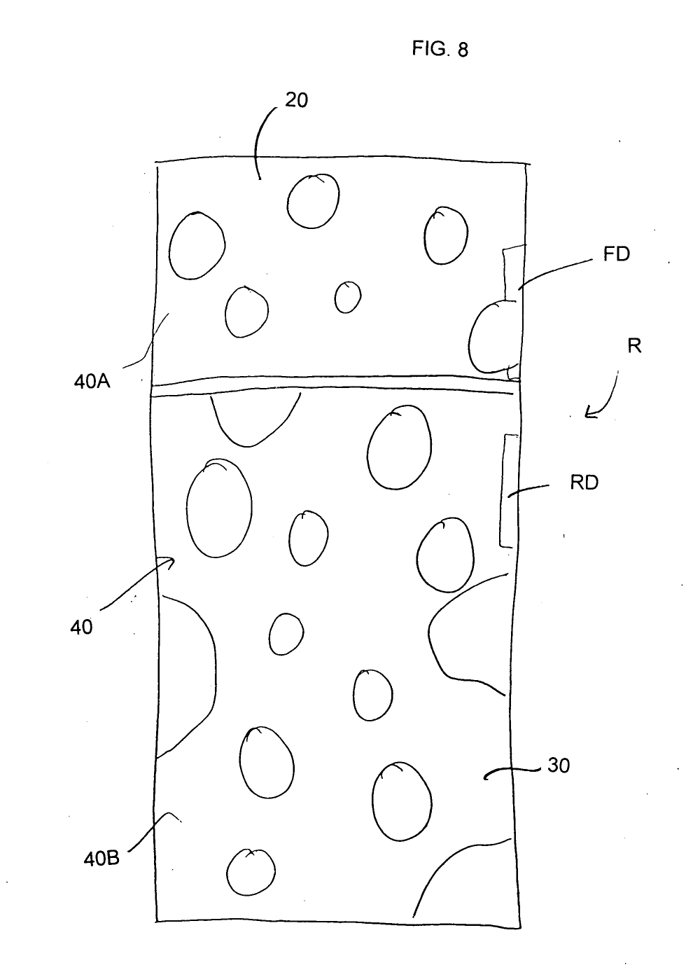

With specific reference to FIG. 8, indicia 40 is preferably in the form of a bubble or spotted motif, wherein first portion 40A depicts the upper portion of the bubble or spotted motif, and wherein second portion 40B depicts the lower portion of the bubble or spotted motif.

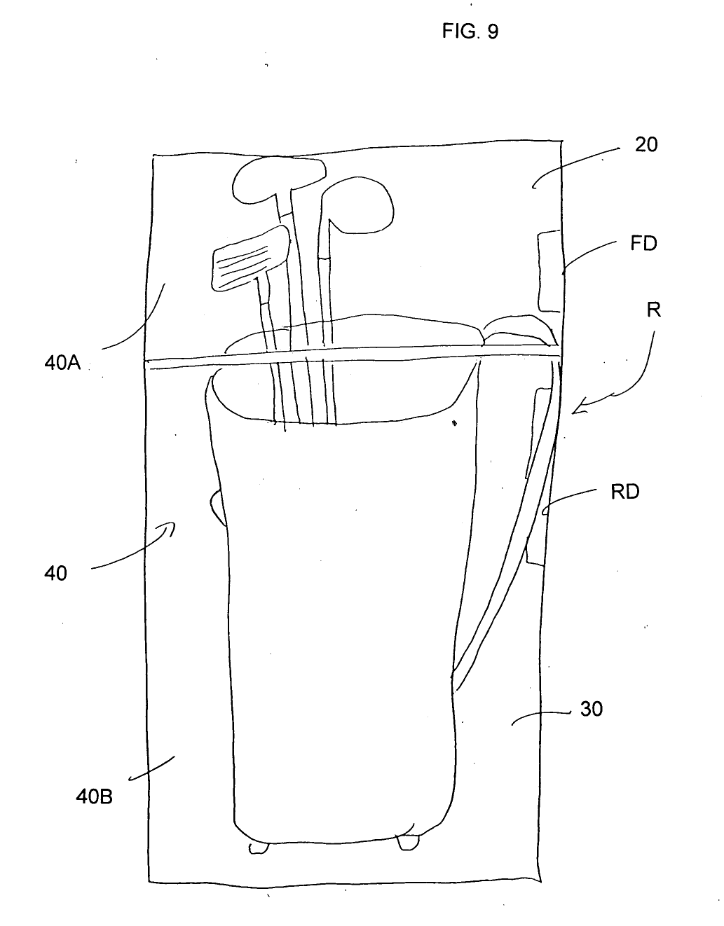

With specific reference to FIG. 9, indicia 40 is preferably in the form of a golf bag, wherein first portion 40A depicts the upper portion of the golf bag, and wherein second portion 40B depicts the lower portion of the golf bag.

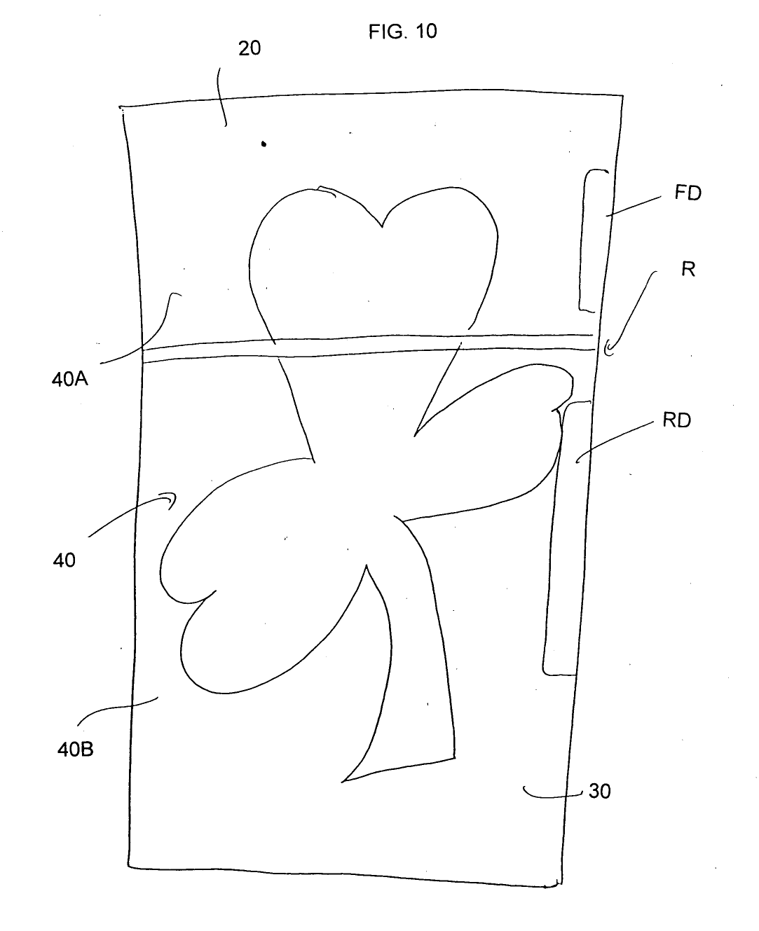

With specific reference to FIG. 10, indicia 40 is preferably in the form of a clover leaf, wherein first portion 40A depicts the upper portion of the clover leaf, and wherein second portion 40B depicts the lower portion of the clover leaf.

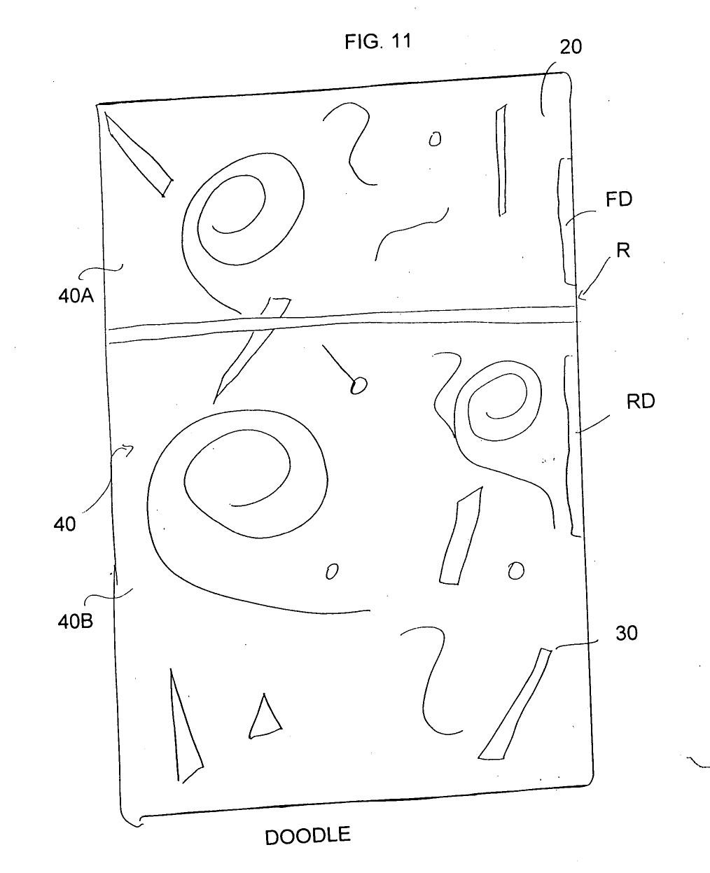

With specific reference to FIG. 11, indicia 40 is preferably in the form of random shapes and lines motif, wherein first portion 40A depicts the upper portion of the random shapes and lines motif, and wherein second portion 40B depicts the lower portion of the random shapes and lines motif.

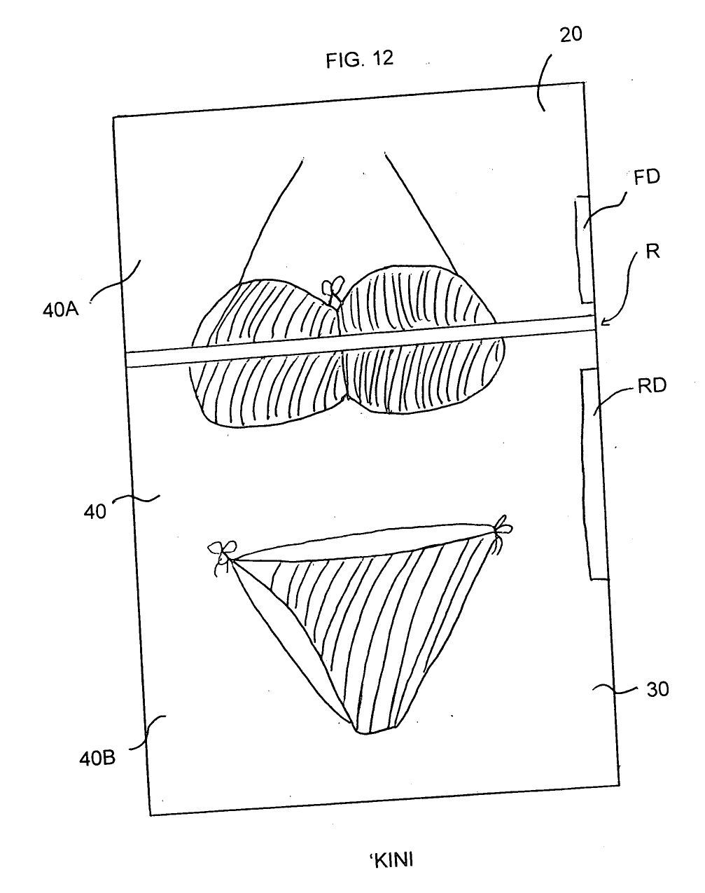

With specific reference to FIG. 12, indicia 40 is preferably in the form of a bathing suit motif, wherein first portion 40A depicts the upper portion of the bathing suit motif, and wherein second portion 40B depicts the lower portion of the bathing suit motif.

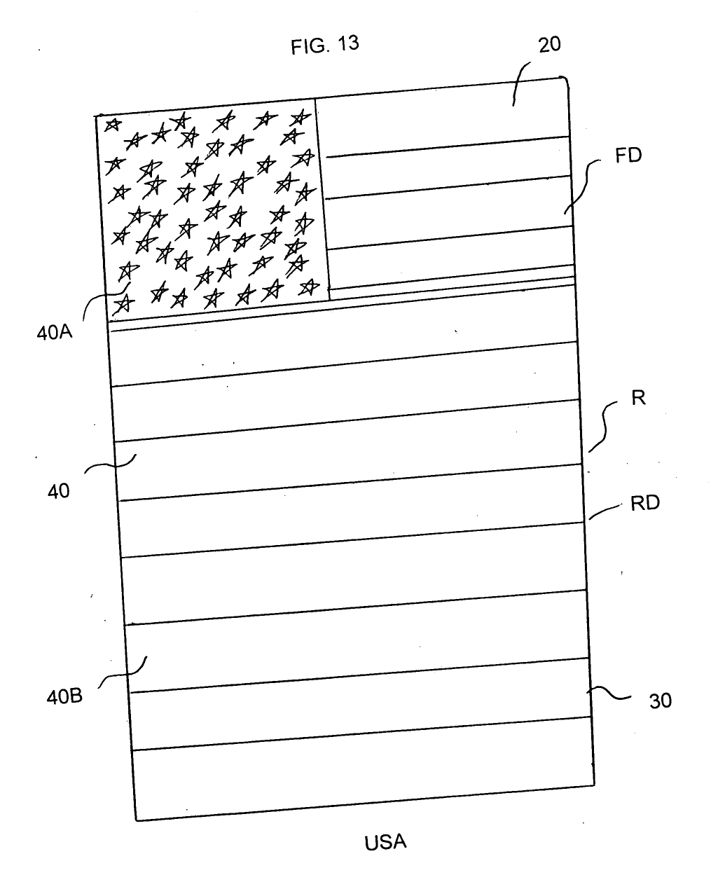

With specific reference to FIG. 13, indicia 40 is preferably in the form of an American flag motif, wherein first portion 40A depicts the upper portion of the American flag motif, and wherein second portion 40B depicts the lower portion of the American flag motif.

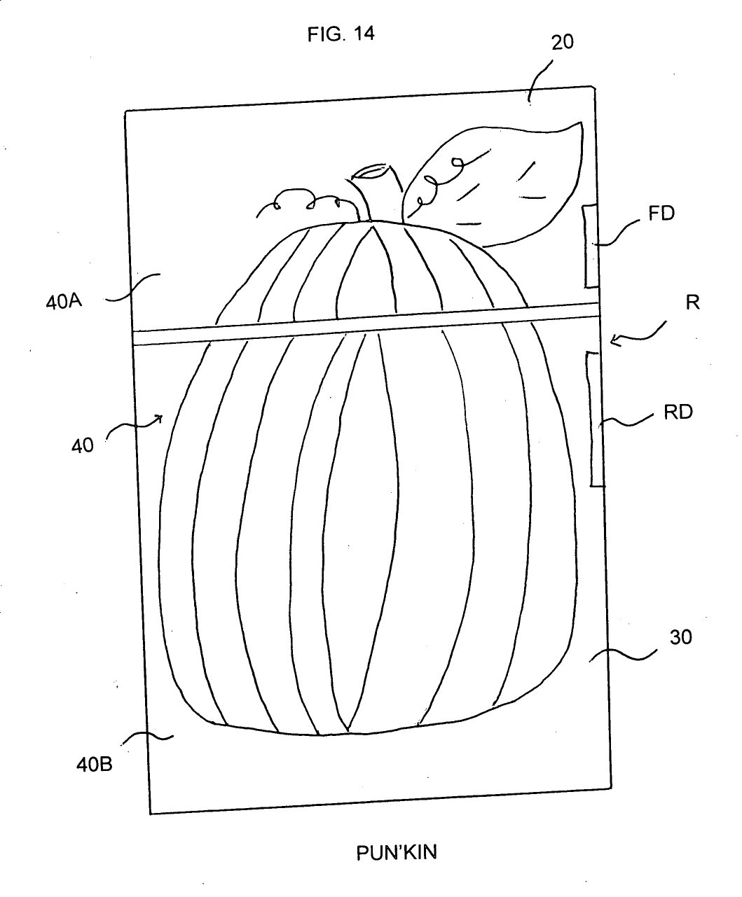

With specific reference to FIG. 14, indicia 40 is preferably in the form of a pumpkin, wherein first portion 40A depicts the upper portion of the pumpkin, and wherein second portion 40B depicts the lower portion of the pumpkin.

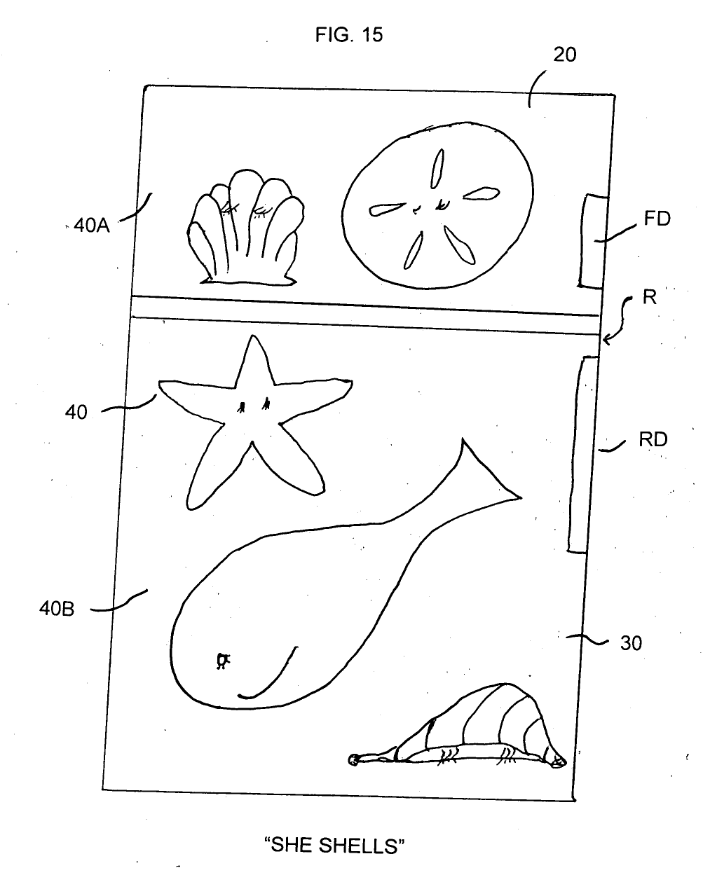

With specific reference to FIG. 15, indicia 40 is preferably in the form of a seashore motif, wherein first portion 40A depicts the upper portion of the seashore motif, and wherein second portion 40B depicts the lower portion of the seashore motif.

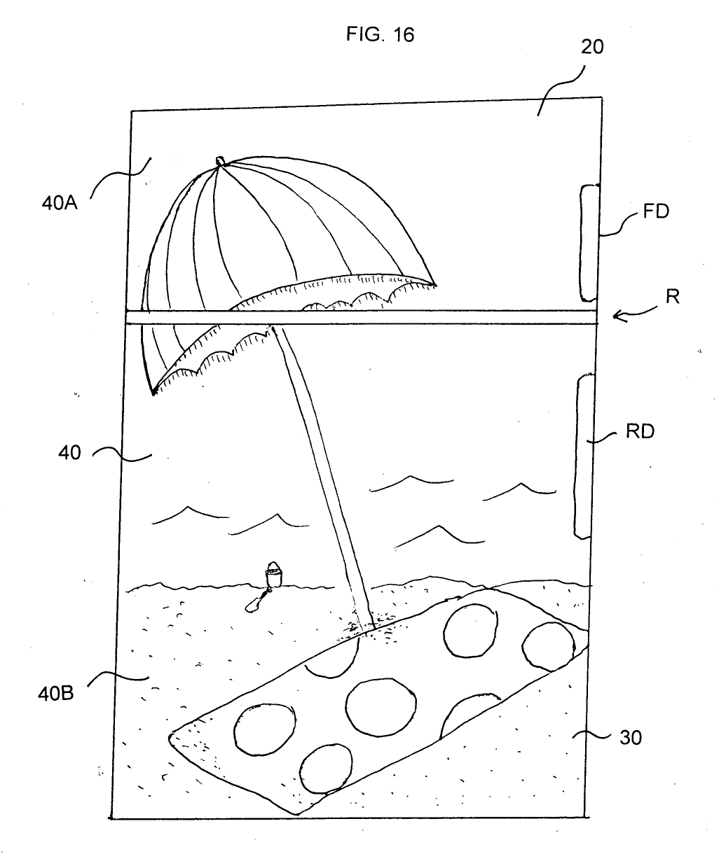

With specific reference to FIG. 16, indicia 40 is preferably in the form of a beach motif, wherein first portion 40A depicts the upper portion of the beach motif, and wherein second portion 40B depicts the lower portion of the beach motif.

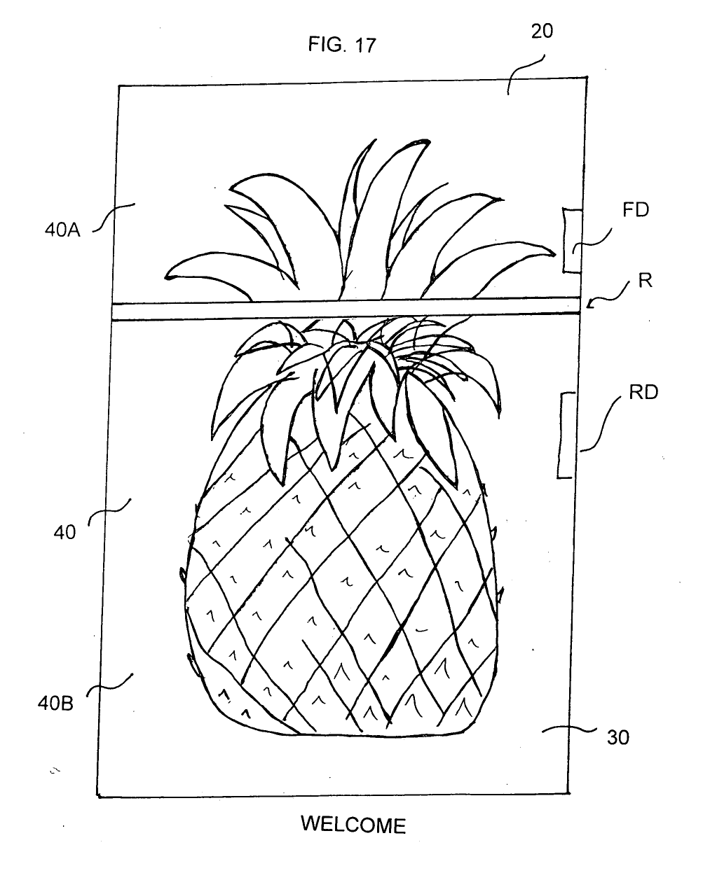

With specific reference to FIG. 17, indicia 40 is preferably in the form of a pineapple, wherein first portion 40A depicts the upper portion of the pineapple, and wherein second portion 40B depicts the lower portion of the pineapple.

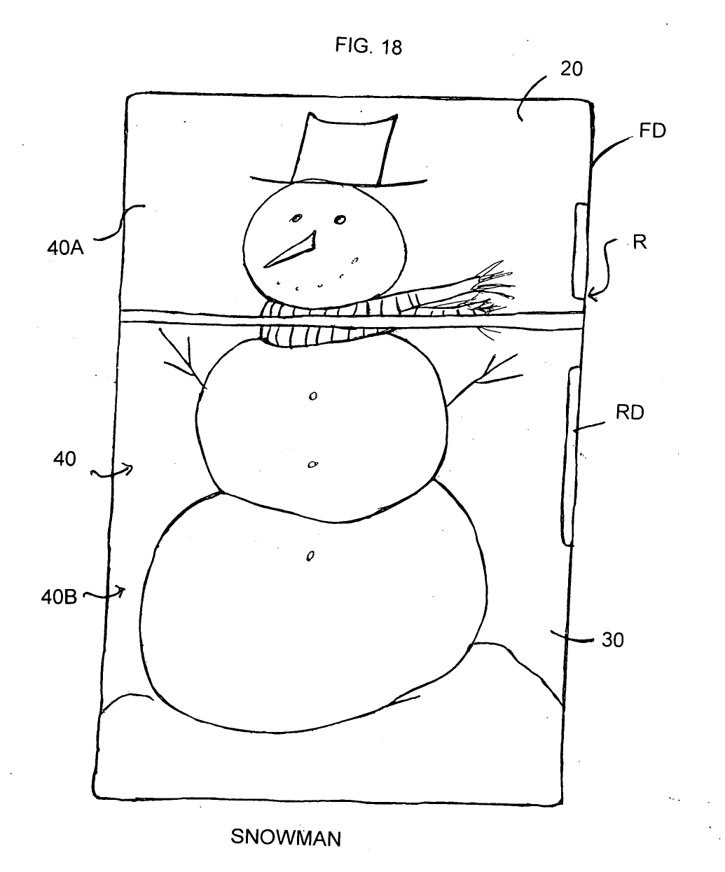

With specific reference to FIG. 18, indicia 40 is preferably in the form of a snowman, wherein first portion 40A depicts the upper portion of the snowman, and wherein second portion 40B depicts the lower portion of the snowman.

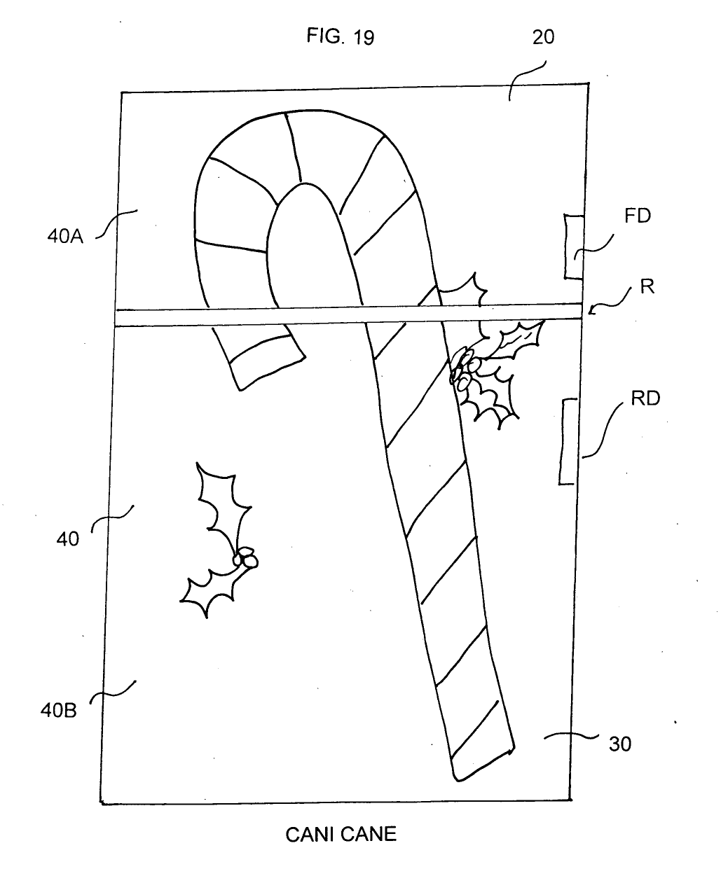

With specific reference to FIG. 19, indicia 40 is preferably in the form of a candy cane, wherein first portion 40A depicts the upper portion of the candy cane, and wherein second portion 40B depicts the lower portion of the candy cane.

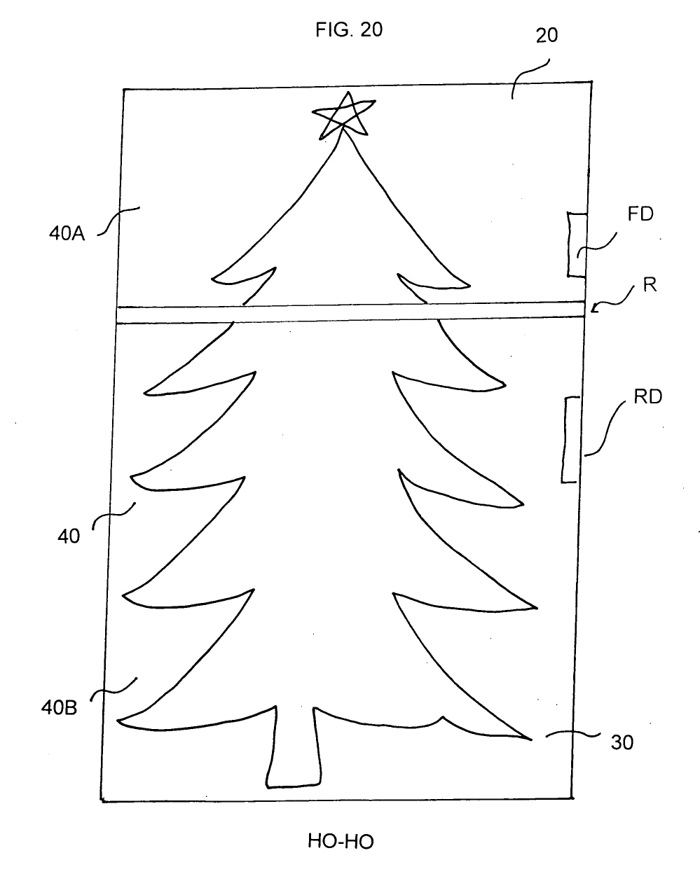

With specific reference to FIG. 20, indicia 40 is preferably in the form of a Christmas tree, wherein first portion 40A depicts the upper portion of the Christmas tree, and wherein second portion 40B depicts the lower portion of the Christmas tree.

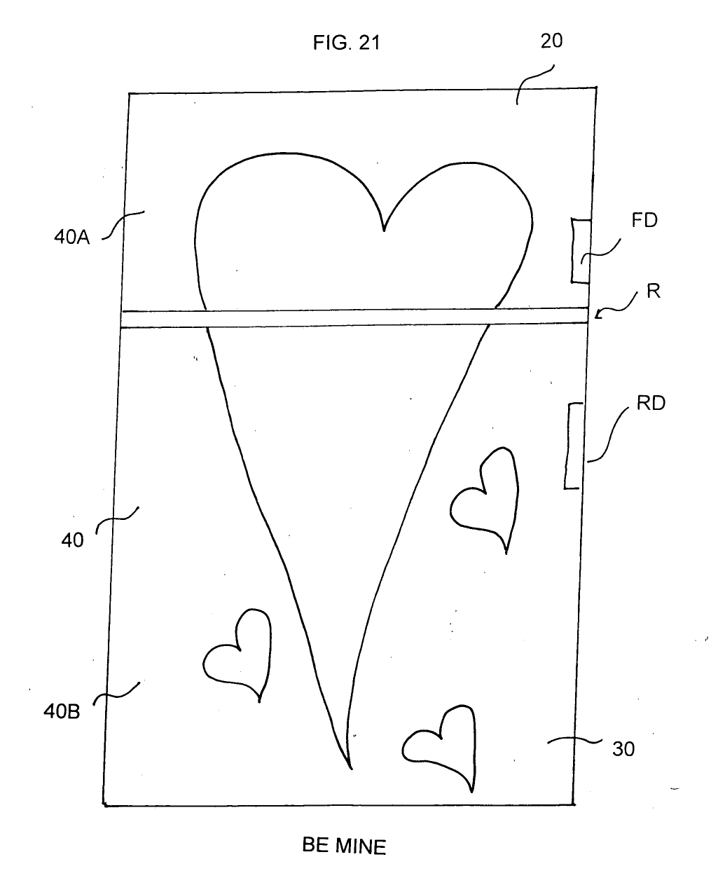

With specific reference to FIG. 21, indicia 40 is preferably in the form of a heart, wherein first portion 40A depicts the upper portion of the heart, and wherein second portion 40B depicts the lower portion of the heart.

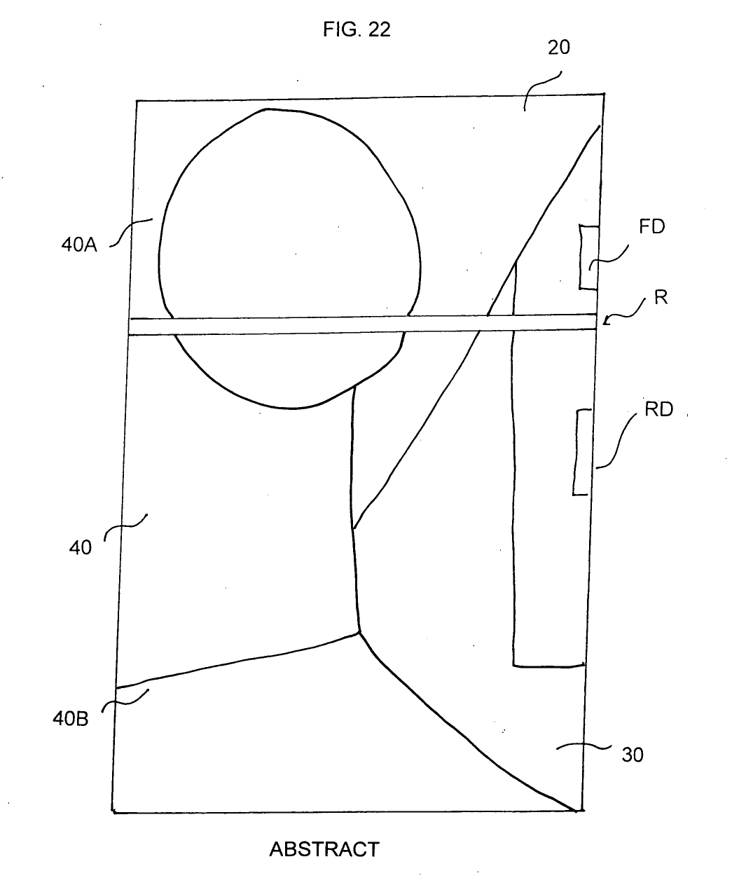

With specific reference to FIG. 22, indicia 40 is preferably in the form of an abstract motif, wherein first portion 40A depicts the upper portion of the abstract motif, and wherein second portion 40B depicts the lower portion of the abstract motif.

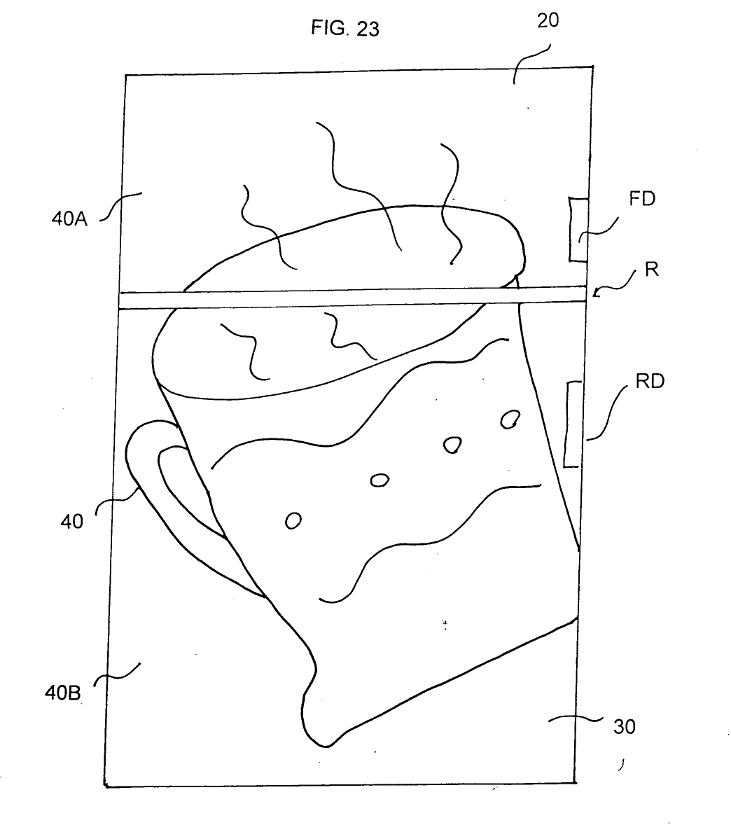

With specific reference to FIG. 23, indicia 40 is preferably in the form of a coffee mug, wherein first portion 40A depicts the upper portion of the coffee mug, and wherein second portion 40B depicts the lower portion of the coffee mug.

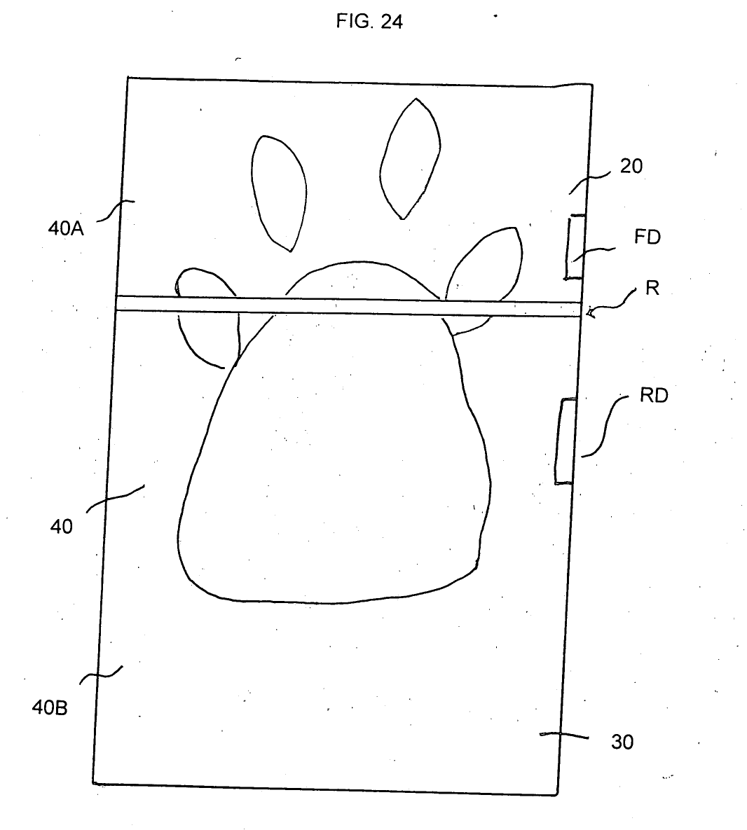

With specific reference to FIG. 24, indicia 40 is preferably in the form of a school logo, wherein first portion 40A depicts the upper portion of the school logo, and wherein second portion 40B depicts the lower portion of the school logo.

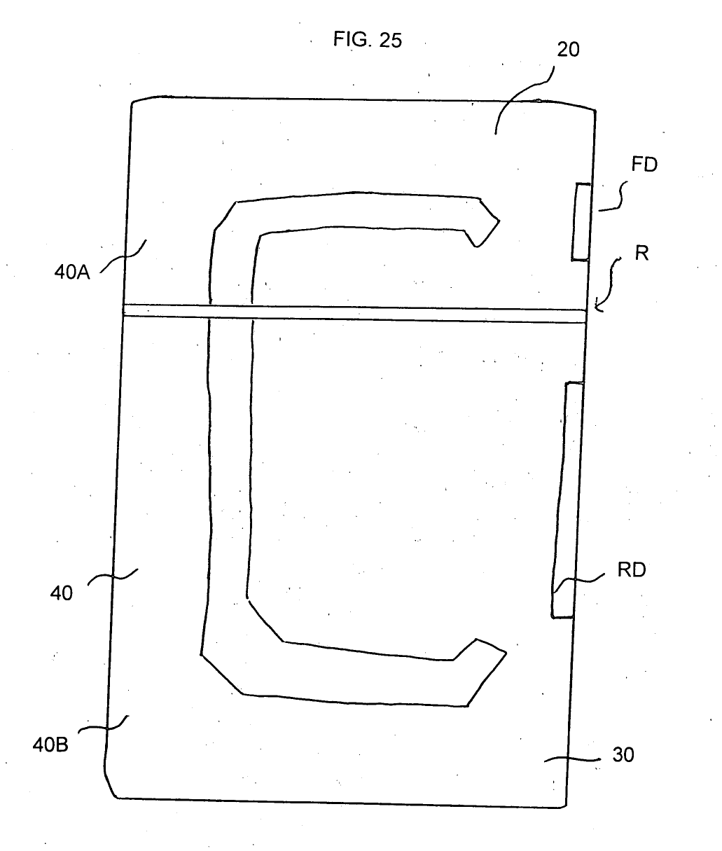

With specific reference to FIG. 25, indicia 40 is preferably in the form of a school letter, wherein first portion 40A depicts the upper portion of the school letter, and wherein second portion 40B depicts the lower portion of the school letter.

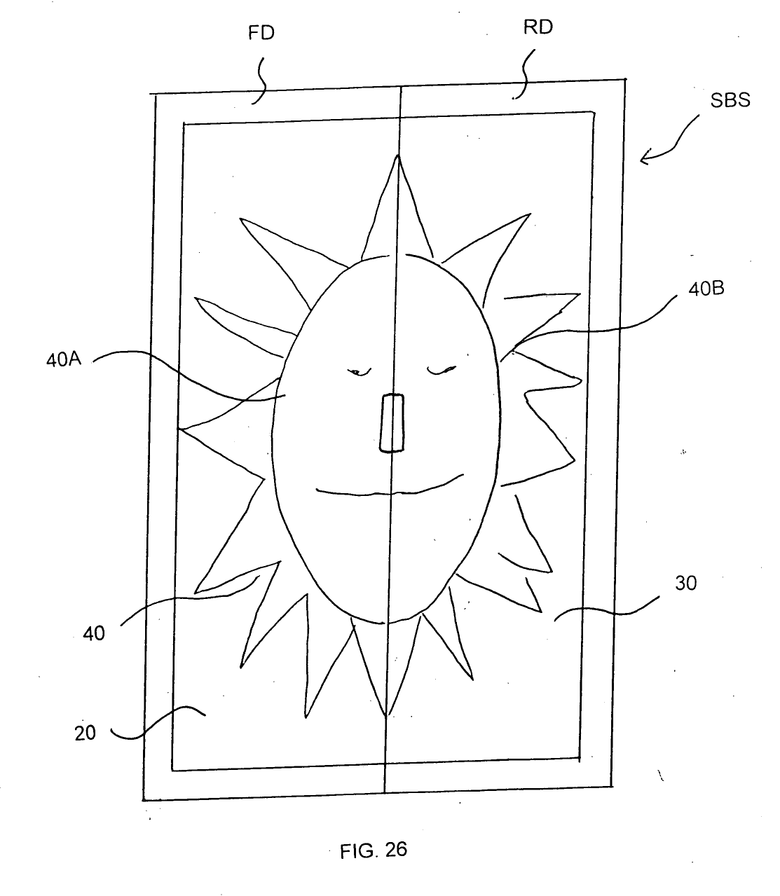

Referring now more specifically to FIG. 26, illustrated therein is an alternate embodiment of apparatus 10, wherein the alternate embodiment of FIG. 26 is substantially equivalent in form and function to that of the preferred embodiment detailed and illustrated in FIGS. 1-25 except as hereinafter specifically referenced. Specifically, the embodiment of FIG. 26 entails dimensioning first section 20 and second section 30 to facilitate accommodation of same onto freezer door FD and refrigerator door RD, respectively, of side-by-side freezer-refrigerator unit SBS, thus displaying completed indicia 40 thereon when freezer door FD and refrigerator door RD are in planar alignment. As illustrated in FIG. 26, indicia 40 is preferably in the form of a sun, wherein first portion 40A depicts the first half of the sun, and wherein second portion 40B depicts the second half of the sun.

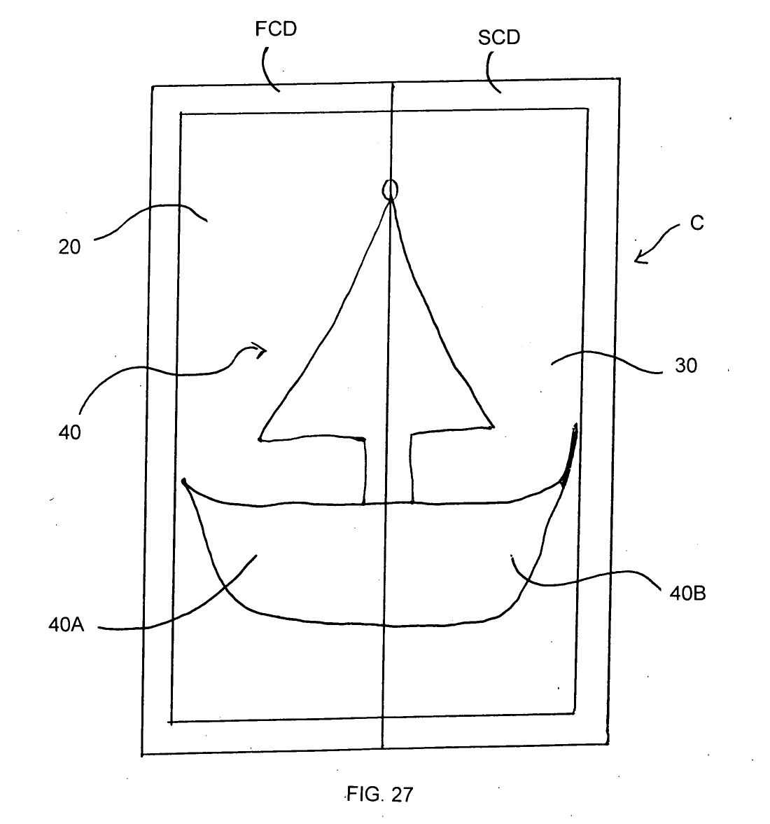

Referring now more specifically to FIG. 27, illustrated therein is an alternate embodiment of apparatus 10, wherein the alternate embodiment of FIG. 27 is substantially equivalent in form and function to that of the preferred embodiment detailed and illustrated in FIGS. 1-25 except as hereinafter specifically referenced. Specifically, the embodiment of FIG. 27 entails dimensioning first section 20 and second section 30 to facilitate accommodation of same onto first closet door FCD and second closet door SCD, respectively, of closet C, thus displaying completed indicia 40 thereon when first closet door FCD and second closet door SCD are in planar alignment. As illustrated in FIG. 27, indicia 40 is preferably in the form of a sailboat, wherein first portion 40A depicts the first half of the sailboat, and wherein second portion 40B depicts the second half of the sailboat.

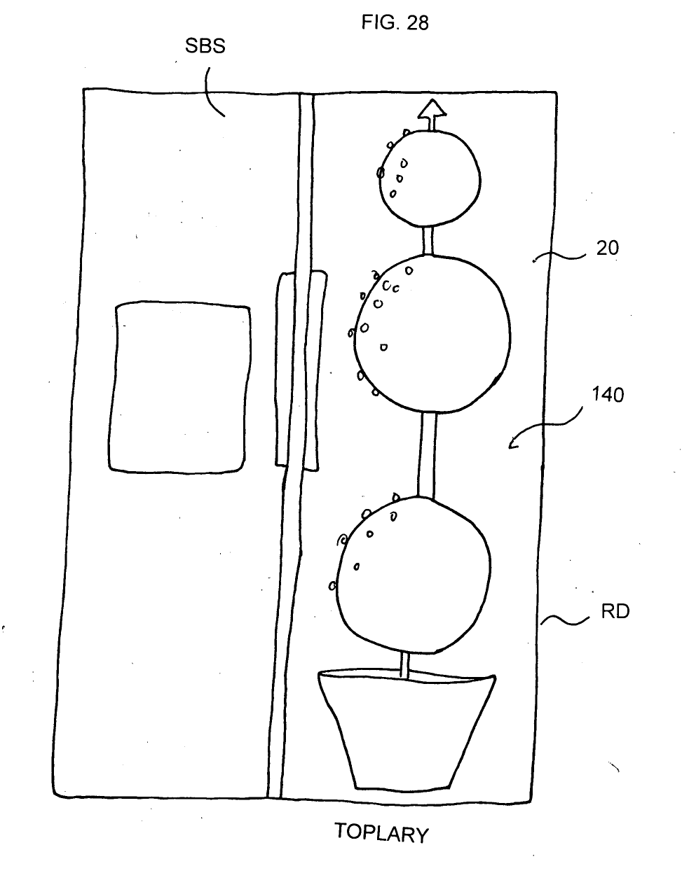

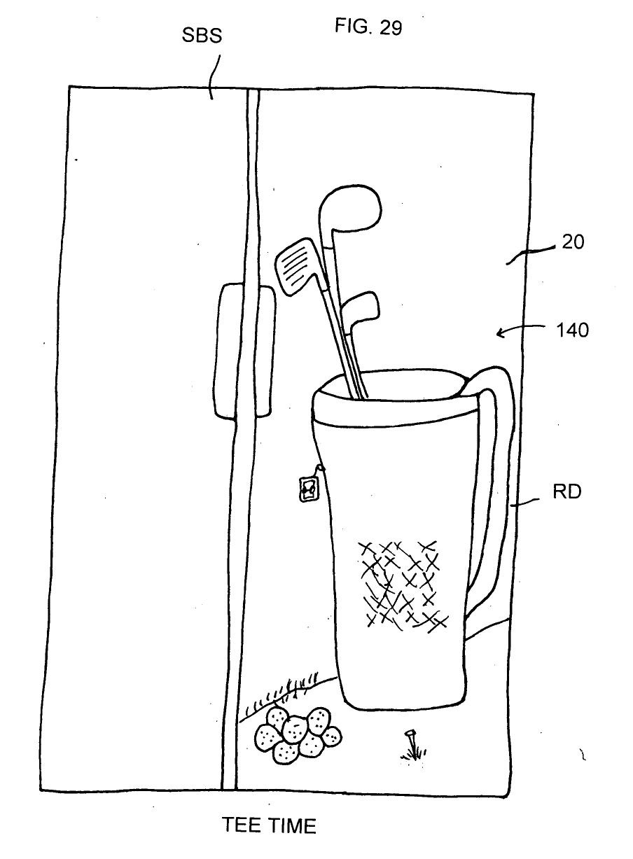

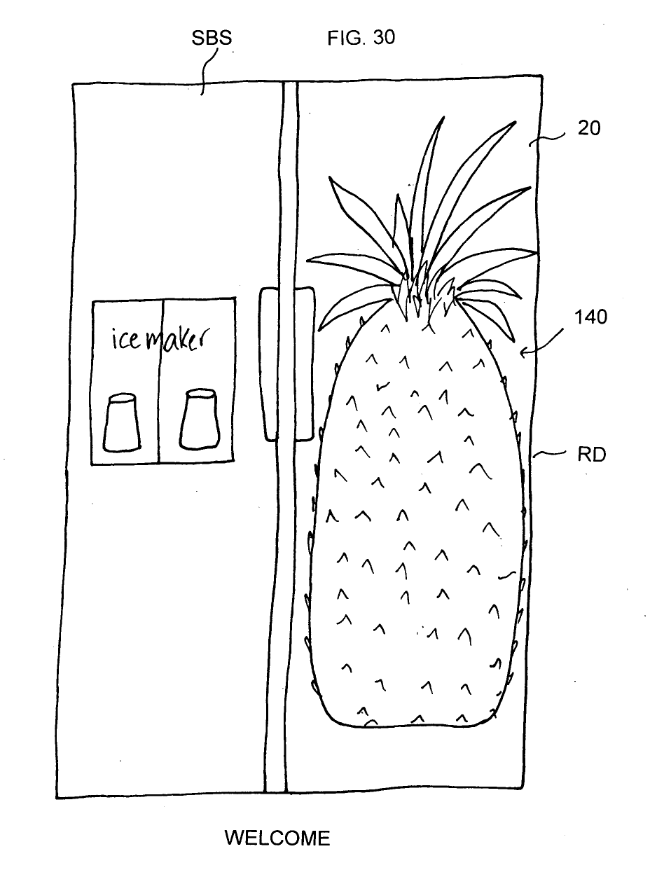

Referring now more specifically to FIGS. 28-30, illustrated therein are alternate embodiments of apparatus 10, wherein the alternate embodiments of FIGS. 28-30 are substantially equivalent in form and function to that of the preferred embodiment detailed and illustrated in FIGS. 1-25 except as hereinafter specifically referenced. Specifically, the embodiments of FIGS. 28-30 entail utilizing only first section 20 dimensioned to facilitate accommodation of same onto refrigerator door RD of side-by-side freezer-refrigerator unit SBS for display of indicia 140 thereon. As illustrated in FIG. 28, indicia 140 of first section 20 is preferably in the form of topiary. As illustrated in FIG. 29, indicia 140 of first section 20 is preferably in the form of a golf bag. As illustrated in FIG. 30, indicia 140 of first section 20 is preferably in the form of a pineapple.

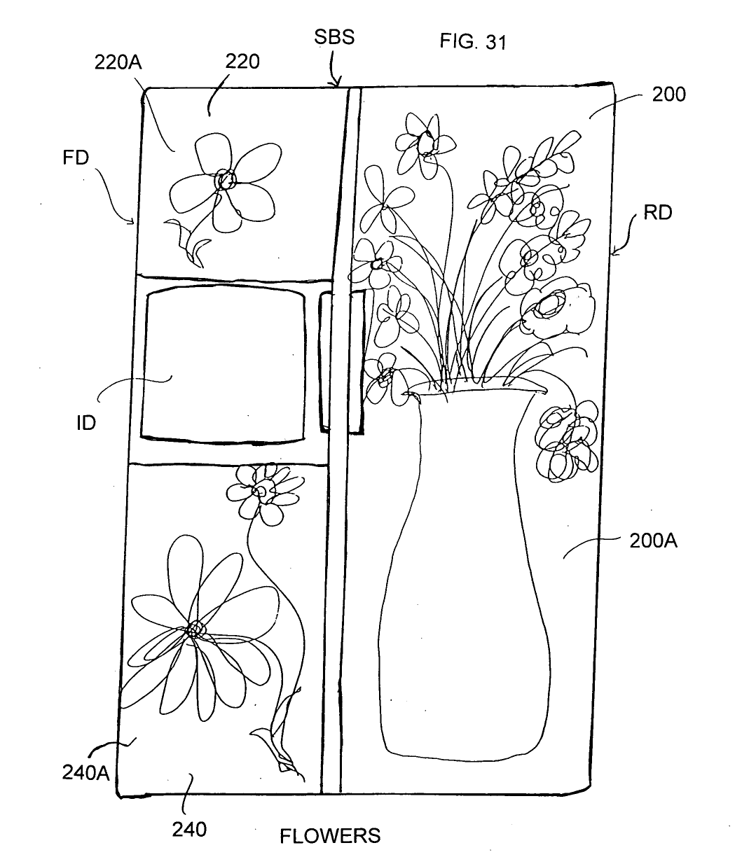

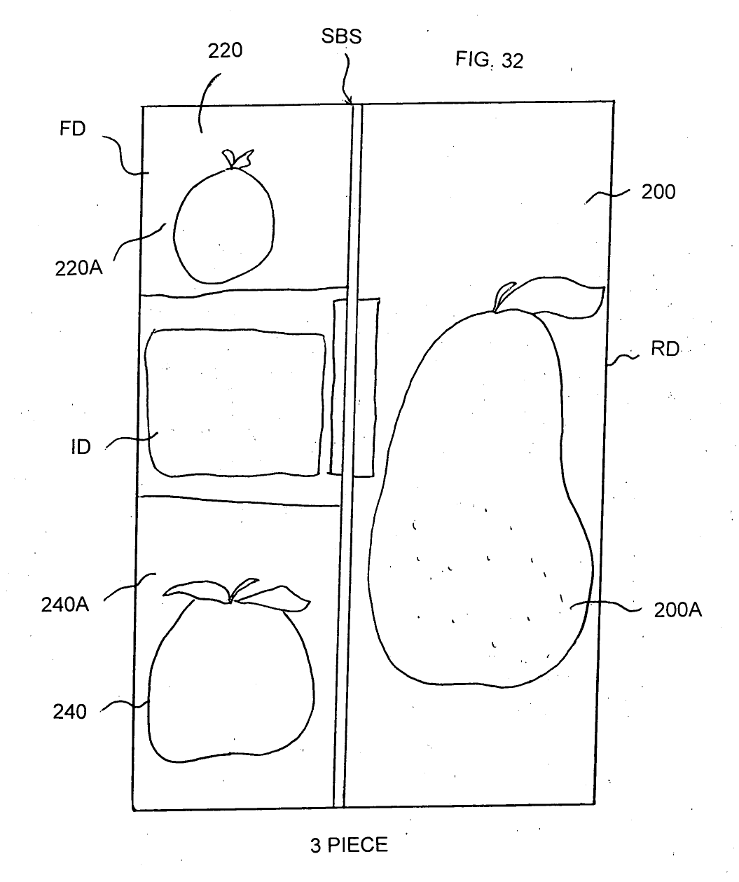

Referring now more specifically to FIGS. 31-32, illustrated therein are alternate embodiments of apparatus 10, wherein the alternate embodiments of FIGS. 31-32 are substantially equivalent in form and function to that of the preferred embodiment detailed and illustrated in FIGS. 1-25 except as hereinafter specifically referenced. Specifically, the embodiments of FIGS. 31-32 entail utilizing three separate or individual sections 200, 220 and 240, each bearing individual indicia 200A, 220A and 240A, respectively, thereon, wherein section 200 is dimensioned to facilitate accommodation of same onto refrigerator door RD, and wherein sections 220 and 240 are dimensioned to facilitate accommodation of same onto freezer door FD of side-by-side freezer-refrigerator unit SBS. However, as illustrated in FIGS. 31-32, ice dispenser ID separates sections 220 and 240 on freezer door FD. As illustrated in FIG. 31, indicia 200A, 220A and 240A of sections 200, 220 and 240, respectively, preferably depict floral arrangements. As illustrated in FIG. 32, indicia 200A, 220A and 240A of sections 200, 220 and 240, respectively, preferably depict fruit.

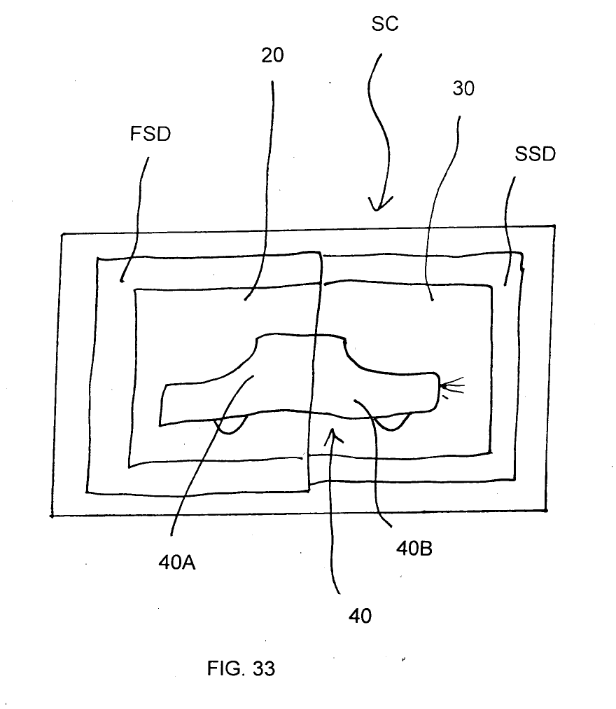

Referring now more specifically to FIG. 33, illustrated therein is an alternate embodiment of apparatus 10, wherein the alternate embodiment of FIG. 33 is substantially equivalent in form and function to that of the preferred embodiment detailed and illustrated in FIGS. 1-25 except as hereinafter specifically referenced. Specifically, the embodiment of FIG. 33 entails dimensioning first section 20 and second section 30 to facilitate accommodation of same onto first laterally sliding door FSD and second laterally sliding door SSD, respectively, of sliding-door style cabinet SC, thus displaying completed indicia 40 thereon when first laterally sliding door FSD and second laterally sliding door SSD are adjacent to one another. As illustrated in FIG. 33, indicia 40 is preferably in the form of a vehicle, wherein first portion 40A depicts the first half of the vehicle, and wherein second portion 40B depicts the second half of the vehicle.

Preferably provided via utilization of apparatus 10, is a method of concealing otherwise mundane or aesthetically displeasing frontal door surfaces of such dual-door or multi-door large kitchen appliances, cabinets, closets, pantries, or the like.

Furthermore, preferably provided via utilization of apparatus 10, is a method of protecting the door surfaces of such dual-door or multi-door large kitchen appliances, cabinets, closets, pantries, or the like, from inadvertent scratches, scraps and/or scuffs, or to conceal pre-existing cosmetic damage.

Although apparatus 10 of the preferred and alternate embodiments provides first section 20 and second section 30, it is contemplated in an alternate embodiment that apparatus 10 could comprise any number of sections to facilitate accommodation of same onto multi-door large kitchen appliances, cabinets, closets, pantries, or the like, of any style, structure or framework, for purposes of providing the aesthetic and protective benefits of apparatus 10.

It is contemplated in another alternate embodiment that indicia 40 could be any picture, logo, message and/or advertisement that would facilitate utilization of apparatus 10 as an advertisings means applicable to large kitchen appliance sales in department stores or the like.

It is contemplated in another alternate embodiment that apparatus 10 could be applied to washer-dryer units, stove-oven units, storage bins, filing cabinets, or the like.

It is contemplated in another alternate embodiment that should a user of device 10 desire application of apparatus 10 over non-magnetically susceptible surfaces, such as wood or plastic, apparatus 10 could be removably affixed to such surfaces via hook-and-loop fasteners, snap-button mechanisms, or the like, thus providing the aesthetic and protective benefits of apparatus 10.

It is contemplated in yet another alternate embodiment that first section 20 and second section 30 of the preferred and alternate embodiments of apparatus 10 could overlap and/or be contiguously positioned.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An apparatus for displayment on an object having at least a first door and at least a second door, said apparatus comprising:
at least one first section having at least one first portion of a selected indicia thereon, said at least one first section adapted to be carried by the at least one first door of the object; and,
at least one second section having at least one second portion of said selected indicia, said at least one second section adapted to be carried by the at least one second door of the object,
wherein planar alignment of the at least one first door with the at least one second door results in at least partial completion of said selected indicia.

2. The apparatus of claim 1, wherein said at least one first section and said at least one second section comprise magnetic backing for magnetic adhesion of said at least one first section and said at least one second section to magnetically susceptible door surfaces.

3. The apparatus of claim 1, wherein said at least one first section and said at least one second section is dimensioned to conceal the front surfaces of the at least one first door and the at least one second door, respectively.

4. The apparatus of claim 1, wherein said at least one first section and said at least one second section protect the front surfaces of the at least one first door and the at least one second door, respectively, from inadvertent scratches, scrapes and scuffs.

5. The apparatus of claim 1, wherein said at least one first section and said at least one second section conceal cosmetic damage on the front surfaces of the at least one first door and the at least one second door, respectively.

6. An apparatus for protecting the front surfaces of adjacent doors from cosmetic damage, said apparatus comprising:
at least one first section having at least one first portion of a selected indicia thereon, said at least one first section adapted to be carried by and cover the front surface of at least one first door; and,
at least one second section having at least one second portion of said selected indicia, said at least one second section adapted to be carried by and cover the front surface of at least one second door,
wherein planar alignment of the at least one first door with the at least one second door results in at least partial completion of said selected indicia.

7. The apparatus of claim 6, wherein said at least one first section and said at least one second section comprise magnetic backing for magnetic adhesion of said at least one first section and said at least one second section to magnetically susceptible door surfaces.

8. The apparatus of claim 6, wherein said at least one first section and said at least one second section conceal the front surfaces of the at least one first door and the at least one second door, respectively.

9. The apparatus of claim 6, wherein said at least one first section and said at least one second section conceal cosmetic damage on the front surfaces of the at least one first door and the at least one second door, respectively.

10. A method of display, comprising the steps of:
a. obtaining an apparatus for display, comprising:
at least one first section having at least one first portion of a selected indicia thereon, said at least one first section adapted to be carried by at least one first door; and,
at least one second section having at least one second portion of said selected indicia, said at least one second section adapted to be carried by at least one second door,
wherein planar alignment of the at least one first door with the at least one second door results in at least partial completion of said selected indicia;
b. placing said at least one first section onto the front surface of the at least one first door;
c. placing said at least one second section onto the front surface of the at least one second door; and,
d. bringing the at least one first door into planar alignment with the at least one second door to at least partially complete said selected indicia.

11. The method of claim 10, wherein said at least one first section and said at least one second section comprise magnetic backing for magnetic adhesion of said at least one first section and said at least one second section to magnetically susceptible door surfaces.

12. The method of claim 10, wherein said at least one first section and said at least one second section conceal the front surfaces of the at least one first door and the at least one second door, respectively.

13. The method of claim 10, wherein said at least one first section and said at least one second section protect the front surfaces of the at least one first door and the at least one second door, respectively, from inadvertent scratches, scrapes and scuffs.

14. The method of claim 10, wherein said at least one first section and said at least one second section conceal cosmetic damage on the front surfaces of the at least one first door and the at least one second door, respectively.
